(19) United States
(12) Patent Application Publication
(10) Pub. No.: US 2004/0034687 A1
(43) Pub. Date: Feb. 19, 2004

(54) Extensible instant messaging service

(75) Inventor: Lee G. Friedman, Alpharetta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BellSouth Intellectual Property Corporation, Wilmington, DE (US)

(21) Appl. No.: 10/211,141

(22) Filed: Aug. 1, 2002

(51) Int. Cl. G06F 15/16

(52) U.S. Cl. 709/205

(57) ABSTRACT

Systems for the deploying an extensible instant messaging service includes a plurality of instant messaging processors and a centralized table accessible to the plurality of instant messaging processors. The centralized table includes information for communicating with users of the instant messaging service. The information on the users remains in the centralized table for as long as the users are connected to the instant messaging service. Other systems and methods are also provided.

### TECHNICAL FIELD

The present invention is generally related to communications and, more particularly, is related to an instant messaging service.

### BACKGROUND OF THE INVENTION

There exists a growing popularity in instant messaging services. Instant messaging is a type of communication using the World Wide Web and/or the Internet to create a group to which members of the group utilize a computing device to communicate with each other via private chat transactions. Service providers typically aim to grow usage of the instant messaging services while users are increasingly demanding a more reliable service.

Current implementations of instant messaging services have fundamental limits on scalability and reliability. Generally the limitations are due to the existing methods and configurations for sharing live data about users currently on the service. Traditional instant messaging systems utilize platforms that are scaled using a distributed model of data sharing. For instance, multiple instance messaging platforms are connected such that data from all users of the instant messaging service is exchanged between the various instant messaging platforms. This configuration is inefficient, and is scalable for a limited number of instant messaging platform servers, e.g., on the order of 2-4 servers. The distributed configuration is not sufficient for growing to a large numbers of users. Further, the ability to provide a reliable 7×24 hour service is limited using the distributed model of data sharing.

Thus, a heretofore-unaddressed need exists for a solution that addresses the aforementioned deficiencies and inadequacies.

### SUMMARY OF THE INVENTION

The preferred embodiments of the present invention provide systems and methods for deploying an extensible instant messaging service.

Briefly described, in architecture, one preferred embodiment of the system, among others, can be implemented as follows. A system for an extensible instant messaging service comprises a plurality of instant messaging processors and a centralized table accessible to the plurality of instant messaging processors. The centralized table, or other memory, includes information for communicating with users of the instant messaging service. The information on the users remains in the centralized table for as long as the users are connected to the instant messaging service.

The preferred embodiment of the present invention can also be viewed as providing methods for deploying an extensible instant messaging service. In this regard, one embodiment of such a method, among others, can be broadly summarized by the following steps: establishing a persistent network connection for a first user of an instant messaging service, updating a centralized database with presence, status or routing information for the first user upon establishment of the persistent network connection for the first user, and maintaining the information on the first user while the first user remains connected to the instant messaging service.

Other systems, methods, features, and advantages of the present invention will be or become apparent to one with skill in the art upon examination of the following drawings and detailed description. It is intended that all such additional systems, methods, features, and advantages be included within this description, and be within the scope of the present invention.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram depicting a preferred embodiment of a system in which an extensible instant messaging system may be implemented.

FIG. 2 is a block diagram depicting a computer or processor-based system that can be used to implement a preferred embodiment of the extensible instant messaging system.

FIG. 3 is a block diagram depicting a preferred embodiment of an illustrative example of a system for implementing an extensible instant messaging system.

FIG. 4 is a block diagram depicting a preferred embodiment of an illustrative example of a system for implementing an extensible instant messaging system.

FIG. 5 is a block diagram depicting a preferred embodiment of an illustrative example of a processor utilized in implementing an extensible instant messaging system.

FIG. 6 is a table depicting a preferred embodiment of an illustrative example of a centralized table implemented in a database of an extensible instant messaging system.

FIG. 7 is a flow chart depicting general functionality of a preferred embodiment for implementing an extensible instant messaging system.

FIGS. 8A-8D are flow charts depicting more specific functionality of a preferred embodiment for implementing an extensible instant messaging system.

### DETAILED DESCRIPTION OF THE PREFERRED EMBODIMENTS

Disclosed herein are systems and methods for deploying an extensible instant messaging service. To facilitate description of the inventive system, an example system that can be used to implement the systems and methods for deploying an extensible instant messaging system is discussed with reference to the figures. Although this system is described in detail, it will be appreciated that this system is provided for purposes of illustration only and that various modifications are feasible without departing from the inventive concept. After the example system has been described, an example of the operation of the system will be provided to explain one manner in which the system can be used to provide for the deployment of extensible instant messaging.

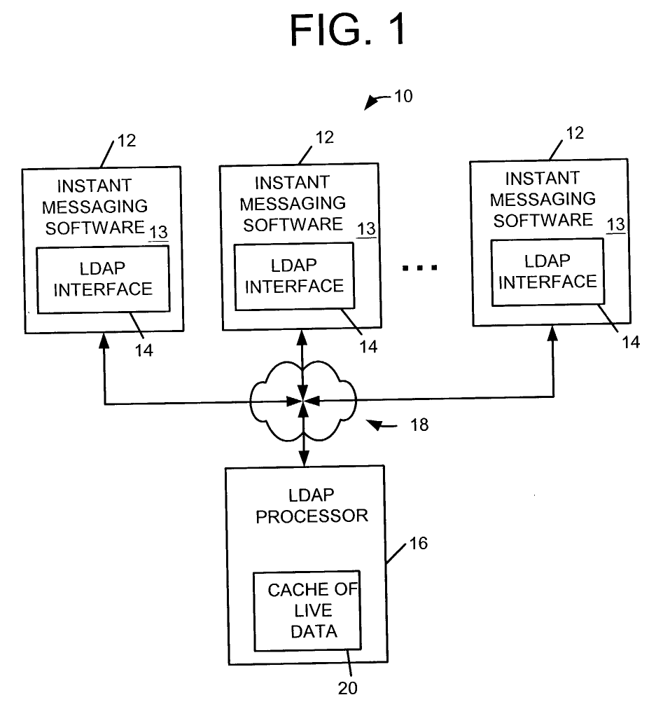

Referring now in more detail to the drawings, in which like numerals indicate corresponding parts throughout the several views, FIG. 1 is a block diagram depicting a preferred embodiment of a system 10 in which extensible instant messaging may be implemented. A preferred embodiment of the system 10 includes front end processing devices 12 such as, clients adapted to provide an instant messaging software 13. In a preferred embodiment, the processing device 12 includes an interface, such as a lightweight directory access protocol (LDAP) interface 14. The LDAP interface 14 is operatively coupled to a processor 16, such as a LDAP processor. The LDAP interface 14 mimics the local data structure and maps it to the shared processor 16. In a preferred embodiment a private communications network 18 connects each instant messaging software 13 to the processor 16. The communications network 18 may be any type of communications network employing any network topology, transmission medium, or network protocol. For example, such a network may be any public or private packet-switched or other data network, including the Internet, circuit-switched network, such as a public switch telecommunications network (PSTN), wireless network, or any other desired communications infrastructure and/or combination of infrastructure.

In a preferred embodiment, the processor 16 includes a cache of live data 20. The data 20 is a shared resource that is configured to be redundant and fault tolerant. In a preferred embodiment, the data 20 is implemented as a database that connects to a client 12 via the LDAP interface 14. In a preferred embodiment, the cache of live data 20 includes a memory resident table of information on users of the instant messaging software 13, including for instance, status and connection information for facilitating chat transactions between users. In an alternative preferred embodiment, the instant messaging service 14 couples to a relational database that includes the live data for facilitating chat transactions between users.

In one embodiment, the system 10 is an extensible instant messaging service that provides for a centralized database(s) that contains live data 20 on users of instant messaging services. The data 20 is a shared resource available to the clients 12, 12A. In one aspect of the invention, balancing client 12, 12A requests for access to the centralized data 20 provides for the extensible instant messaging, and by storing the data 20 in a centralized manner, the data 20 is accessible by users as needed to facilitate transactions between users.

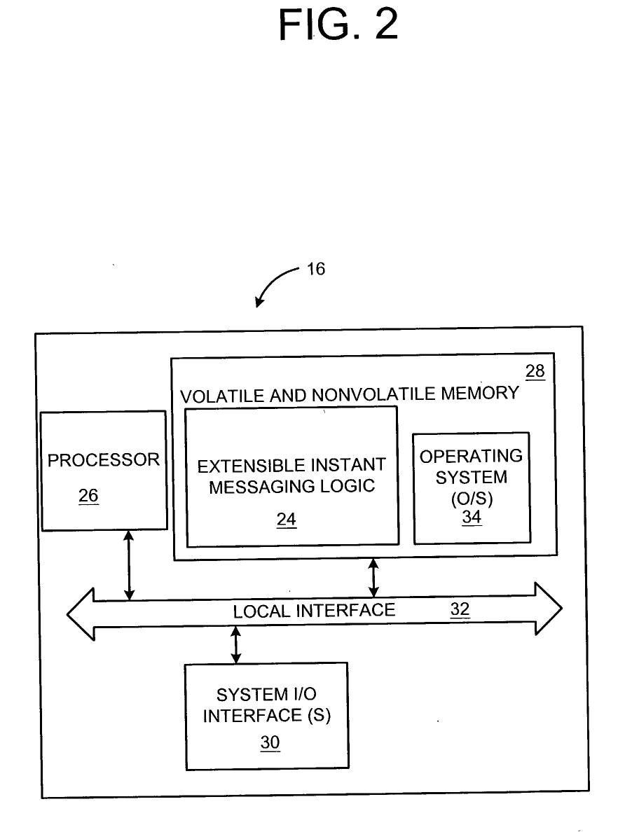

FIG. 2 is a block diagram depicting a computer or processor-based system 16 that can be used to implement a preferred embodiment for the deployment of an extensible instant messaging system. As shown in FIG. 2, the deployment of extensible instant messaging logic 24 can be implemented in software (e.g., programming stored on a medium, firmware, etc.), hardware, or a combination thereof. In the preferred embodiments, the extensible instant messaging logic 24 is implemented in software as an executable program, and is executed by a special or general purpose digital computer, such as a personal computer (PC; IBM-compatible, Apple-compatible, or otherwise), workstation, minicomputer, or mainframe computer. An example of a general-purpose computer that can implement the extensible instant messaging logic 24 of the preferred and alternate embodiments of the present invention is shown in FIG. 2.

Generally, in terms of hardware architecture, as shown in FIG. 2, the digital computer 16 includes, inter alia, a processing device 26 and memory 28. Input and/or output (I/O) devices 30 (or peripherals) can be communicatively coupled to a local interface 32. The local interface 32 can be, for example but not limited to, one or more buses or other wired or wireless connections, as is known in the art. The local interface 32 may have additional elements, which are omitted for simplicity, such as controllers, buffers (caches), drivers, repeaters, and receivers, to enable communications. Further, the local interface 32 may include address, control, and/or data connections to enable appropriate communications among the aforementioned components.

The processing device 26 is preferably a hardware device for executing software, particularly that stored in memory 28. The processing device 26 can preferably be any custom made or commercially available processor, a central processing unit (CPU), an auxiliary processor among several processors, a semiconductor based microprocessor (in the form of a microchip or chip set), a macroprocessor, or generally any device for executing software instructions.

The memory 28 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 28 may incorporate electronic, magnetic, optical, and/or other types of storage media. Note that the memory 28 can have a distributed architecture, where various components are situated remote from one another, but can be accessed by the processing device 26.

The software and/or firmware in memory 28 may include one or more separate programs, each of which comprises an ordered listing of executable instructions for implementing logical functions. In the example of FIG. 2, the software in the memory 28 includes the extensible instant messaging logic 24 and a suitable operating system (O/S) 34. The operating system 34 essentially controls the execution of other computer programs, such as the extensible instant messaging logic 24, and provides scheduling, input-output control, file and data management, memory management, and communication control and related services.

The extensible instant messaging logic 24 is preferably a source program, executable program (object code), script, or any other entity comprising a set of instructions to be performed. When the extensible instant messaging logic 24 is implemented as a source program, then the program needs to be translated via a compiler, assembler, interpreter, or the like, which may or may not be included within the memory 28, so as to operate properly in connection with the O/S 34. Furthermore, the extensible instant messaging logic 24 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices 30 may preferably include input devices, for example but not limited to, a keyboard, mouse, scanner, microphone, etc. Furthermore, the I/O devices 30 may also include output devices, for example but not limited to, a printer, display, etc. Finally, the I/O devices 30 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

When the extensible instant messaging logic 24 is implemented in software, as is shown in FIG. 2, it should be noted that the extensible instant messaging logic 24 can preferably be stored on any computer-readable medium for use by or in connection with any computer related system or method. The extensible instant messaging logic 24 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. If implemented in hardware, as in an alternative embodiment, the extensible instant messaging logic 24 can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

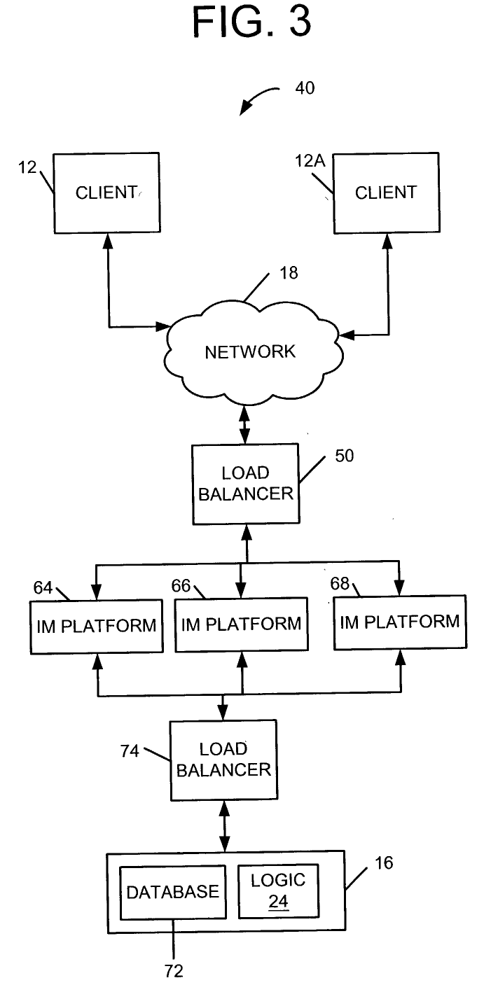

FIG. 3 is a block diagram depicting a preferred embodiment of an illustrative example of a system 40 for implementing an extensible instant messaging system 10. The system 40 includes a plurality of computing devices such as clients 12, 12A that are coupled to the communications network 18. A load balancer 50 is coupled to the communications network 18 and provides for balancing traffic loads, such as chat transactions, from the clients 12, 12A. The load balancer 50 is coupled to a plurality of computing devices configured as instant messaging platforms (IM platforms) 64-66. The IM platforms 64-68 provide for routing from one client 12 to another client 12A such that a persistent network connection is established between client 12 and client 12A. A load balancer 74 balances the load from the IM platforms 64-68 that request access to the processor 16. The processor 16 includes a database 72 and logic such as extensible instant messaging logic 24. The database 72 includes information on clients 12, 12A, including but not limited to status of client 12, 12A, i.e. whether the client 12, 12A is logged in, availability of client 12, 12A, for instance is the client 12, 12A available for a chat transaction, and the IM platform 64-68 is assigned to the client 12, 12A.

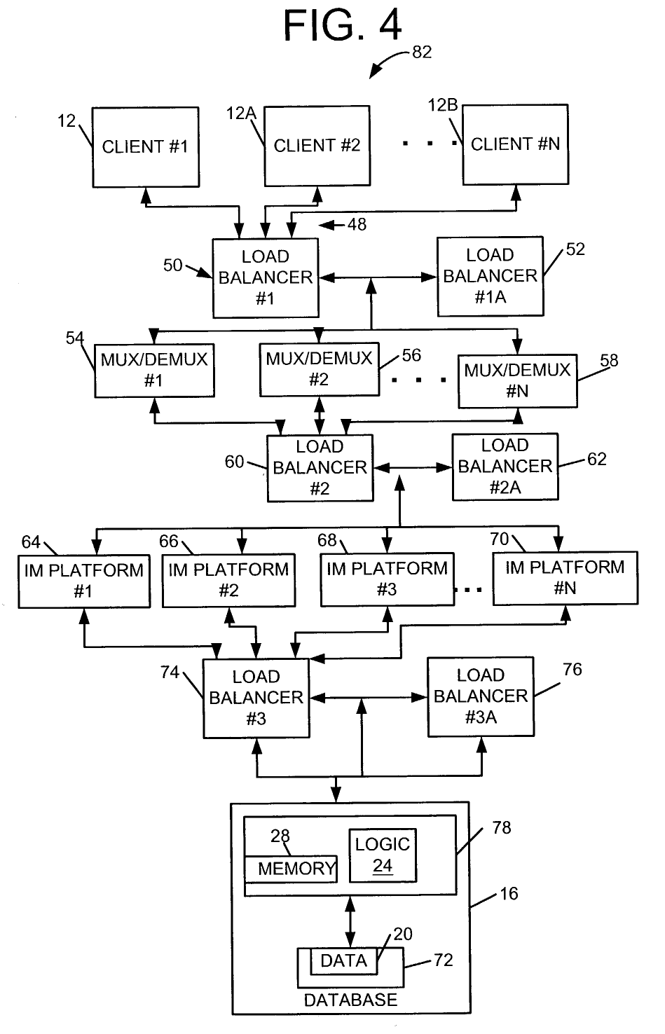

FIG. 4 is a block diagram depicting another preferred embodiment of an illustrative example of a system 82 for implementing an extensible instant messaging system 10. The system 82 includes a plurality of computing devices such as clients 12, 12A and 12B. The clients 12, 12A and 12B are operatively coupled to a load balancer 50. In a preferred embodiment, the clients 12, 12A and 12B utilize a communications network 48, such as the Internet, to connect to the load balancer 50.

In a preferred embodiment, the load balancer 50 is paired with another load balancer 52 for redundancy to provide a high availability of the system 82. Each load balancer 50, 52 is configured to process jobs from clients 12, 12A and 12B. Although a client 12, 12A and 12B may be assigned to a primary load balancer 50, 52 the other load balancer 50, 52 will assume the load of the other if necessary. For instance, if one load balancer 50, 52 fails, the other load balancer 50, 52 assumes the load for both load balancers 50, 52. For simplicity, only two load balancers 50, 52 are shown in FIG. 4, however, the invention is not limited to only two load balancers 50, 52. A suitable load balancer for use with the invention is available from Cisco Systems, among others.

A plurality of multiplexer/demultiplexers (Mux/Demux) 54, 56, and 58, are operatively coupled to the load balancers 50, 52. Typically, the Mux/Demux 54, 56 and 58 combines multiple signals from the load balancers 50, 52 such that the signals can be transmitted over a single medium. The multiplexed signals received from the single medium are separated using the demultiplexer. In a preferred embodiment, the load balancers 50, 52 efficiently distribute chat transactions from the clients 42, 44, and 46 to the next available Mux/Demux 54, 56 and 58. Further, the load balancer 50, 52 is adapted to recognize that transactions between clients 12, 12A and 12B are persistent network sessions. A persistent network session is a connection between the load balancer 50, 52 and Mux/Demux 54, 56 and 58 that is maintained throughout a chat transaction. However, the load balancer 50, 52 can move a connected session to a different Mux/Demux 54, 56, and 58 as necessary for load balancing or reliability, or other reasons.

The Mux/Demux 54, 56 and 58 is operatively coupled to a load balancer 60. In a preferred embodiment, the load balancer 60 is paired with another load balancer 62 to provide redundancy and high availability of the system 82. The load balancers 60, 62 efficiently distribute transactions from the Mux/Demuxs 54, 56, and 58 to a plurality of computing devices configured as instant messaging platforms 64-70. In addition, the load balancers 60, 62 maintain mapping information regarding which client 12, 12A and 12B is connected to which Mux/Demux 54, 56, 58.

In a preferred embodiment, the instant messaging (IM) platforms 64-70 provide for routing one client 12, 12A and 12B to another client 12, 12A and 12B such that the users of the clients 12, 12A and 12B can have a persistent network connection with each other. A pair of load balancers 74, 76 connect the IM platforms 64-70 to the processor 16. In a preferred embodiment, the processor 16 includes a plurality of servers 78 (only one shown for simplicity). A database 72 is operatively coupled to the server 78. The database 72 includes information on clients 12, 12A and 12B, including but not limited to status of client 12, 12A and 12B, i.e. whether the client 12, 12A and 12B is logged in, availability of client 12, 12A and 12B, which Mux/Demux 54, 56 and 58 and IM platform 64-70 is assigned to the client 12, 12A and 12B. In a preferred embodiment, the servers 78 include a memory 28, and extensible instant messaging logic 24. The IM platforms 64-70 manage reading, writing and modifying table entries in the database 72.

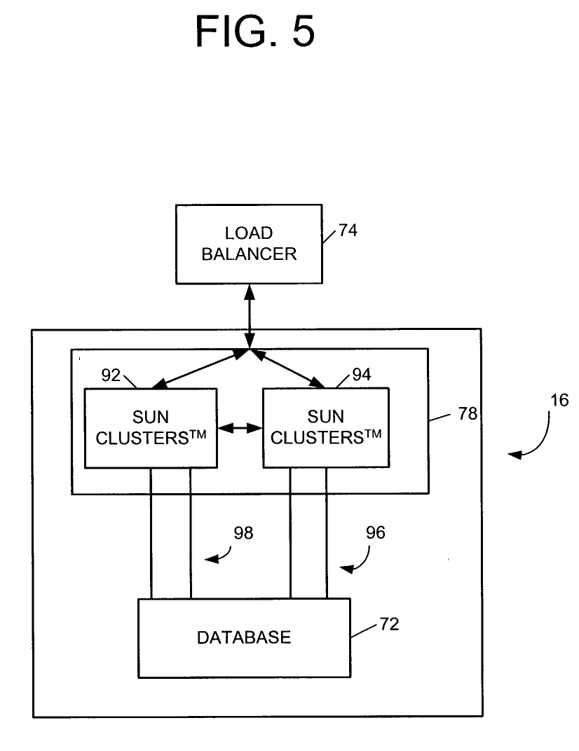

FIG. 5 is a block diagram depicting a preferred embodiment of an illustrative example of the processor 16 for implementing an extensible instant messaging system. The processor 16 couples to load balancer 74 (only one shown for simplicity). The processor 16 is configured to handle a large number of transactions and to provide a high availability for the system 40, 82. The load balancer 74 sends transactions to the processor 16. In a preferred embodiment, the processor 16 includes a database engine adapted to interface with an associated database available on disk. In a preferred embodiment, the processor 16 includes a server 78 (only one shown for simplicity), for example a Sun Solaris™ operating environment, extensible instant messaging logic 24 (not shown) and a database 72. The Sun Solaris™ is designed for multiprocessing, 64 bit computing, and handling heavy traffic loads and huge data sets. In a preferred embodiment, the database 72 is one available from EMC Corporation, among others, having capacity in the terabytes. The Sun Solaris™ 78 includes a pair of Sun Cluster™ software 92, 94. Sun Cluster™ software enables the use of the Sun Solaris™ services such as file service and the abstraction of stored data. In a preferred embodiment, traffic from chat transactions is balanced between two Sun Clusters™ 92, 94 that communicate between each other. Each Sun Cluster™ 92, 94 knows jobs that the other is processing. In the event of a failure, the working Sun Cluster™ 92, 94 completes the job of the failed Sun Cluster™ 92, 94. The pairing of processing done by the Sun Clusters™ 92, 94 is preferably done in a manner transparent to the load balancer 74. In a preferred embodiment, a pair of redundant fiber optic cables 96, 98 provide for communications between the server 78 and the database 72, such that no single point of failure exists in the communications network.

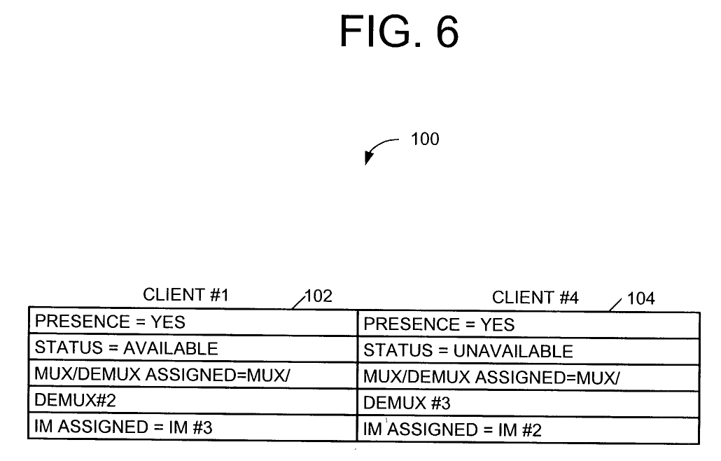

FIG. 6 is a table 100 depicting a preferred embodiment of an illustrative example of a centralized table implemented in a database 72 of an extensible instant messaging system. In a preferred embodiment, the table 100 is memory resident in the database 72 that is maintained during the chat transaction. Thus, entries in the table 100 are relevant for the time period that a client 12, 12A and 12B is logged into the system 40, 82. When a client 12, 12A and 12B logs off, the information for that client 12, 12A and 12B in the table 100 is not saved.

For simplicity, the table 100 shows only two columns of information, however, the invention is not limited to only two columns of information. The first column 102, contains information about client #1. The second column 104, contains information about client #4. Information about client #1 and client #4 can include presence, status, Mux/Demux assignments and IM assignment, among others. In the example shown in FIG. 6, client #1 is present, indicating that client #1 is logged in. An available presence indication can also mean that client #1's status is available indicating that client #1 has not denoted that it is unavailable by sending a “do not disturb” or other unavailable signal, through the system 40. Further, the table shows that client #1 is assigned Mux/Demux #2 and IM #3.

The second column 104 provides information on client #4. Client #4 is also logged in as denoted by his presence noted as affirmative. However, client #4 status is unavailable. Therefore, Client #1 would be unable to have a chat transaction with client #4 until client #4 changes its status to available. In addition, the table 100 shows that client #4 is assigned Mux/Demux #3 and IM #2.

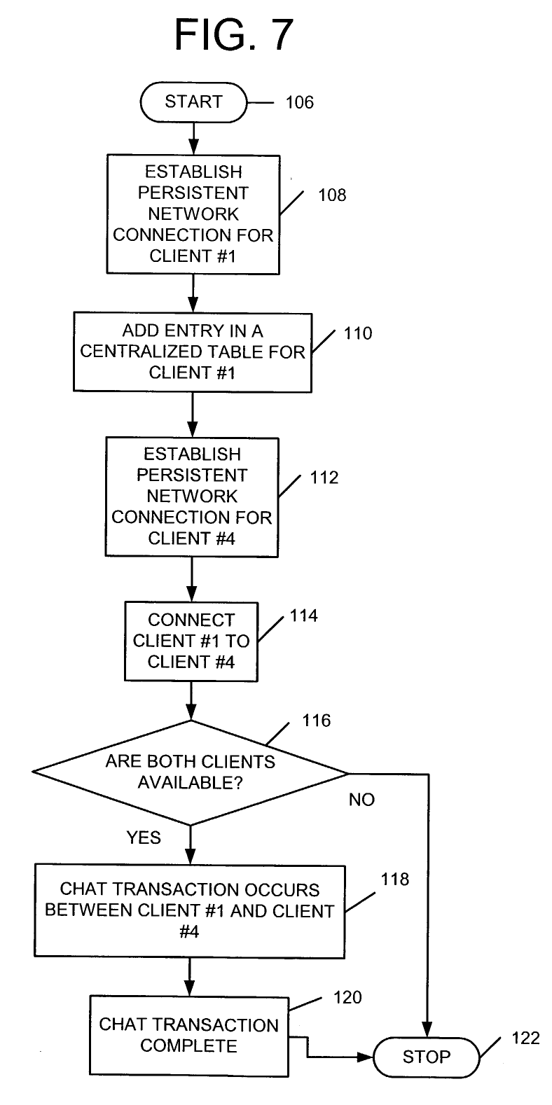

FIG. 7 is a flow chart depicting general functionality (or a method) of a preferred embodiment for implementing an extensible instant messaging system. The process begins at 106. At 108, if not previously established, a persistent network connection is established for client #1, i.e., a connection is maintained for client #1 for the duration of the transaction. However, the system can move that connection to other equipment, e.g., another Mux/Demux, as long as the move is transparent to the client. At 110, an entry in a table in a database is made providing information on client #1, including but not limited to, whether client #1 is logged in and available for a transaction, and assignment of Mux/Demux and IM platforms. At 112, a persistent network connection is established for client #4. At 114, client #1 is connected to client #4. At 116, a determination is made as to whether client #1 and client #4 are available. If client #1 and client #4 have identified that they are available, at 116, at 118, a chat transaction occurs between client #1 and client #4. At 120, the chat transaction ends. The process ends at 122. If client #1 and/or client #4 have indicated that they are not available, a chat transaction does not occur between client #1 and client #4, and the process ends at 122.

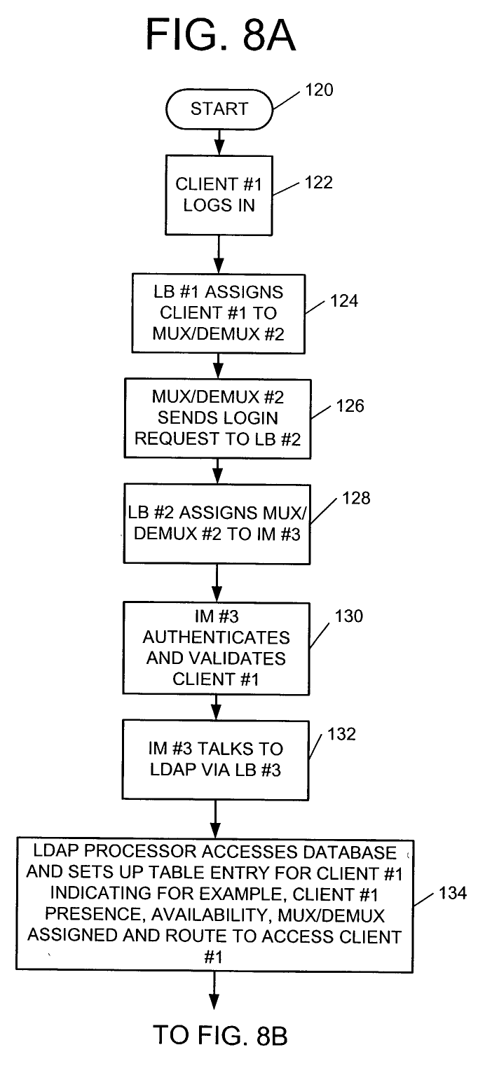

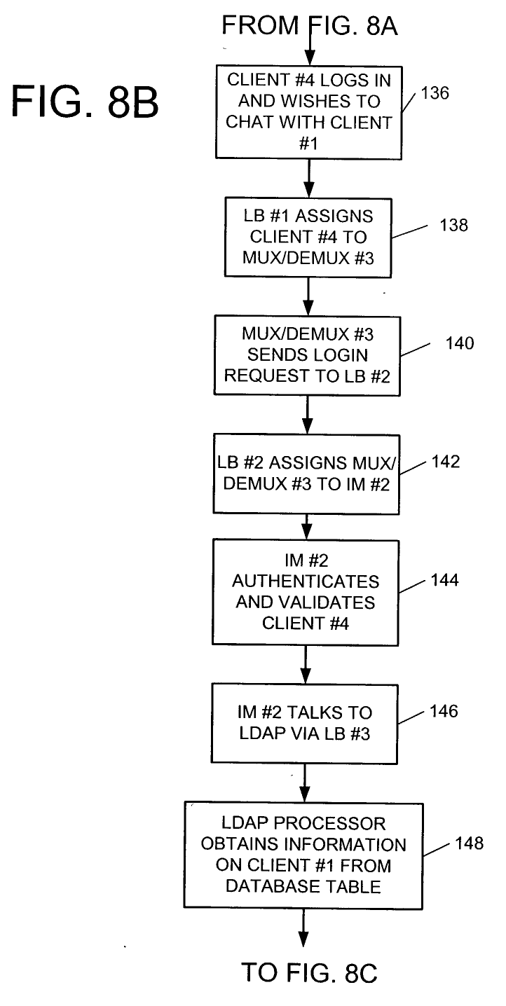

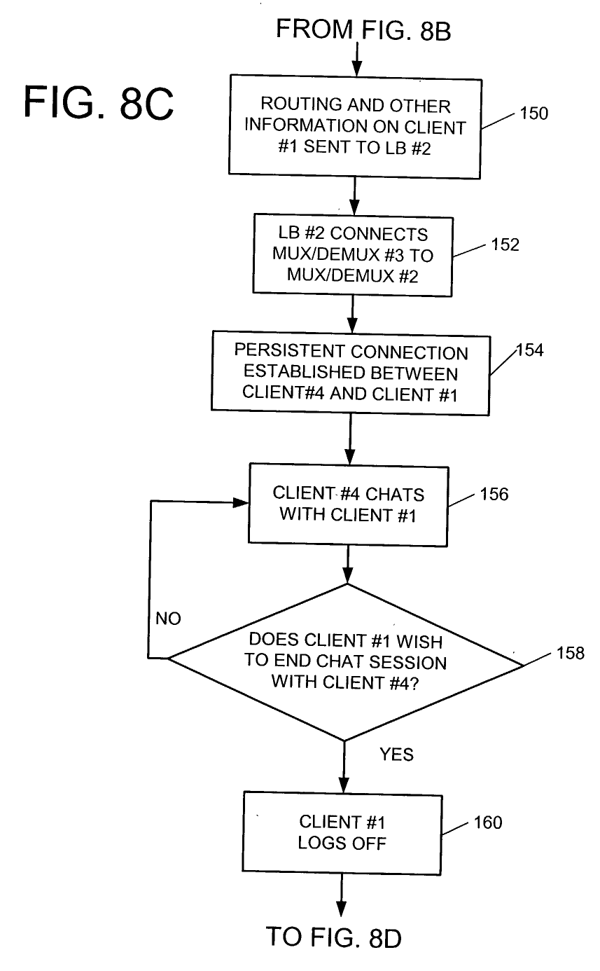

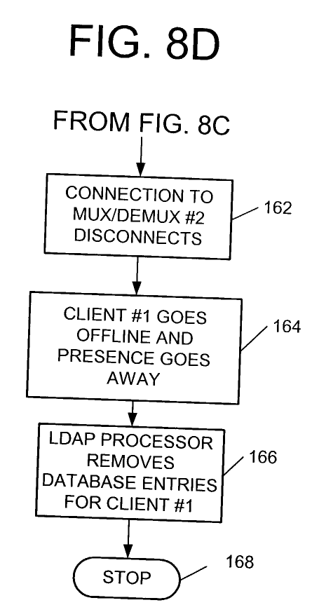

FIGS. 8A-8D are flow charts depicting more specific functionality (or method) of a preferred embodiment of a deployment of an extensible instant messaging system. The process begins at 120. At 122, client #1 logs into the extensible instant messaging system. Upon a successful log in, client #1's presence will be made available to other members of client #1's instant messaging group. In a preferred embodiment, client #1's login request traverses over the Internet or other communications network, to a load balancer. At 124, load balancer #1 assigns Mux/Demux #2 to client #1. In a preferred embodiment, a private communications network is utilized to connect Mux/Demux #2 to the load balancers. At 126, Mux/Demux #2 sends client #1's login request to load balancer #2. The Mux/Demux maintains an IP address for the connection to load balancer #2. Load balancer #2, at 128, assigns Mux/Demux #2 to Internet Messaging Service (IM) #3. At 130, IM #3 authenticates and validates client #1 by for example verifying a password assigned to client #1. At 132, IM #3 connects to load balancer #3, which is connected to a LDAP processor.

At 134, the LDAP processor accesses a database that includes tables for entering information on clients. The LDAP processor reads, writes, and modifies table entries, as necessary, including table entries for client #1. Client #1's presence is indicated in the table based upon the login of client #1. Other examples of table entries include, but are not limited to, status, i.e., available or not, Mux/Demux assigned to the client, route used to connect client #1 to the system and IM assigned.

Referring to FIG. 8B, the process continues at 136, with another client, for instance, client #4 logging in and wishing to chat with client #1. At 138, load balancer #1 assigns client #4 to Mux/Demux #3. Mux/Demux #3, at 140, sends the login request to load balancer #2. At 142, load balancer #2 assigns Mux/Demux #3 to IM #2. At 144, IM #2 authenticates and validates client #4. At 146, IM #2 connects to load balancer #3, which is connected to the LDAP processor.

Providing information regarding client #1 to client #4 is necessary for client #4 to chat with client #1. The information needed by client #4 resides in a table in the database. At 148, the LDAP processor obtains the required information about client #1 from the table in the database. The information includes the Mux/Demux assigned to client #1, (i.e., Mux/Demux #2) and the IM assigned, (i.e., IM #3). In addition, client #4 will be notified of the status of client #1, (i.e., whether client #1 is available for a chat transaction).

Referring to FIG. 8C, the process continues at 150, with routing and other pertinent information on client #1 being sent to load balancer #2. At 152, load balancer #2 connects Mux/Demux #3 to Mux/Demux #2. At 154, a persistent connection is established between client #4 and client #1. If both clients are available, at 156, client #4 chats with client #1. At 158, a determination is made as to whether one of the clients, for example client #1, wishes to end the chat session with client #4. If no, at 156, the chat transaction continues. If yes, at 160, client #1 logs off. Client #1 might provide notification to client #4 of a desire to log off by sending a good-bye or other message, or client #1 may just log off.

Referring to FIG. 8D, the process continues at 162 with client #1's connection to Mux/Demux #2 being disconnected. At 164, client #1 goes offline and the presence of client #1 disappears. To remove client #1's presence, at 166, the LDAP processor removes database entries for client #1. The process ends at 168.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The preferred embodiment of the present invention provide centralized, fault tolerant storage of data and provide systems and methods for a reliable failover of components and reduced server to server traffic and data redundancy with centralized live data. A load balanced scalable solution for instant messaging service is also provided.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A system for an extensible instant messaging service, comprising:
a plurality of instant messaging processors; and
a centralized table accessible to the plurality of instant messaging processors, the centralized table including information for communicating with users of an instant messaging service, the information on the users remaining in the centralized table while the users are connected to the instant messaging service.

2. The system of claim 1, further comprising a plurality of front end processing devices that are operatively coupled to the plurality of instant messaging processors, and wherein the centralized table is isolated from the plurality of front end processing devices.

3. The system of claim 2, further comprising a first plurality of load balancers that are operatively coupled to the plurality of instant messaging processors and the centralized table, the first plurality of load balancers for balancing and distributing transactions from the plurality of instant messaging processors to the centralized table.

4. The system of claim 3, further comprising a second plurality of load balancers that are operatively coupled to the plurality of front end processors and the plurality of instant messaging processors, the second plurality of load balancers for balancing and distributing transactions from the plurality of front end processing devices to the plurality of instant messaging processors.

5. The system of claim 4, further comprising a plurality of multiplexer/demultiplexers that are operatively coupled to the second plurality of load balancers and the plurality of instant messaging processor, the plurality multiplexer/demultiplexers maintaining communications between the plurality of front end processing devices and the first plurality of load balancers.

6. The system of claim 5, further comprising a third plurality of load balancers that are operatively coupled to the plurality of multiplexer/demultiplexers and the plurality of instant messaging processors, the plurality of third load balancers for balancing and distributing the transactions to the plurality of instant messaging processors.

7. The system of claim 1, wherein the centralized table includes a table of at least one of presence, status or routing information for the front end processing devices.

8. The system of claim 7, wherein the table resides in a cache memory of the centralized table.

9. The system of claim 8 wherein the cache memory devices and the centralized table are configured as a lightweight directory access protocol (LDAP) system.

10. An extensible instant messaging service system, comprising:
a plurality of instant messaging processors;
a database accessible to the plurality of instant messaging processors, the database including information for communicating with users of an instant messaging service, the information on the users remaining in the database while the users are connected to the instant messaging service; and
a plurality of front end processing devices that are operatively coupled to the plurality of instant messaging processors and wherein the front end processing devices are isolated from the database.

11. The system of claim 10, wherein the database further comprises a table having information for establishing, maintaining and removing transactions among the users of the instant messaging service.

12. The system of claim 10, wherein the database comprises a relational database.

13. The system of claim 10, wherein the database comprises a memory resident flat file.

14. The system of claim 10, wherein the database is configured as a lightweight directory access protocol system.

15. The system of claim 11, wherein the information in the table includes at least one of a user's status, presence, or routing information.

16. A system for providing an extensible instant messaging service, comprising:
means for processing an instant messaging service; and
means for centralizing data that interfaces with the means for processing, the means for centralizing data including a table having information on users of an instant messaging service while the users remain connected to the instant messaging service.

17. The system of claim 16, further comprising means for balancing and distributing transactions from a means for front end processing to the means for processing an instant messaging service.

18. The system of claim 17, further comprising means for balancing and distributing transactions from the means for processing an instant messaging service to the means for centralizing data.

19. A method for deploying an extensible instant messaging service, comprising the steps of:
establishing a persistent network connection for a first user of an instant messaging service;
updating a centralized database with at least one of presence, status or routing information for the first user upon establishment of the persistent network connection for the first user; and
maintaining the information on the first user while the first user remains connected to the instant message service.

20. The method of claim 19, further comprising establishing a persistent network connection for a second user of the instant messaging service.

21. The method of claim 20, further comprising accessing the centralized database to obtain information on the first user such that the second user can establish a chat session with the first user.

22. The method of claim 21, further comprising establishing a chat session between the first user and the second user.

23. The method of claim 22, further comprising removing information from the centralized database when a persistent network connection for a user is disconnected.

24. A computer-readable medium having a computer program for efficiently exchanging text based protocol languages, comprising:
logic configured to establish a persistent network connection for a first user of an instant messaging service;
logic configured to update a centralized database with at least one of presence, status or routing information for the first user upon establishment of the persistent network connection for the first user; and
logic configured to maintain the information on the first user while the first user remains connected to the instant message service.

25. The computer-readable medium of claim 24, further comprising logic configured to establish a persistent network connection for a second user of the instant messaging service.

26. The computer-readable medium of claim 25, further comprising logic configured to access the centralized database to obtain information on the first user such that the second user can establish a chat session with the first user.

27. The computer-readable medium of claim 26, further comprising logic configured to establish a chat session between the first user and the second user. 28. The computer-readable medium of claim 27, further comprising logic configured to remove information from the centralized database when a persistent network connection for a user is disconnected.
